(19) United States
(12) Patent Application Publication
(10) Pub. No.: US 2012/0184377 A1
(43) Pub. Date: Jul. 19, 2012

(54) Elastic Coupling in Disc Construction

(76) Inventors: Gregor Polifke, Giengen (DE); Rolf Brockmann, Heidenheim (DE); Franz Brenner, Nattheim (DE); Werner Koch, Deggingen (DE); Achim Menne, Crailsheim (DE)

(21) Appl. No.: 13/321,000

(22) PCT Filed: May 20, 2010
(86) PCT No.: PCT/EP10/03110

§ 371 Date: Dec. 30, 2011

(30) Foreign Application Priority Data
Jun. 17, 2009 (DE) 10 2009 025 642.3

(51) Int. Cl. F16D 3/80; F16F 15/16

(52) U.S. Cl. 464/7; 464/24

(57) ABSTRACT

The invention relates to an elastic coupling in disc construction, in particular for damping torsional vibrations of an internal combustion engine, having the following features:
a first coupling half, which comprises two side discs, which are connected in a rotationally-fixed manner on the outer circumference;
a second coupling half, which is formed by at least one middle disc assigned to a hub, which is arranged between the side discs and enveloped thereby;
the two coupling halves are pivotable to a limited extent to one another against the force of at least one elastic coupling element;
the side discs delimit a liquid-tight inner space, which receives the middle disc,
at least one damping chamber, which is variable in volume during the mutual pivoting of the coupling halves and is filled with a damping medium, is arranged in the radial outer area of the inner space;
a floating damping ring, which is pivotable to a limited extent in relation to each of the two coupling halves, is introduced into the inner space, the damping ring forming at least one first partial chamber of the damping chamber with the first coupling half and forming at least one second partial chamber of the damping chamber with the second coupling half;
the floating damping ring being divided over the circumference of the coupling into individual ring segments, which are separate from one another, and which are mounted to slide on the radial exterior on the middle disc and/or on the radial interior on an outer edge of at least one side disc.

The elastic coupling according to the invention is characterized
in the state which is not loaded in the peripheral direction by the damping medium or one of the two coupling halves, the ring segments, at one or both axial ends, have a predefined spacing in the radial direction of the coupling in relation to the middle disc and/or in relation to the outer edge of at least one side disc, and
the ring segments are mounted in a bending or tilting manner on the middle disc and/or at least one side disc in such a manner that the predefined spacing at the axial end of the ring segments in relation to the middle disc and/or the outer edge of at least one side disc is bridged by bending or tilting in the state of the ring segments which is loaded in the peripheral direction by the damping medium or one of the two coupling halves.

The present invention relates to an elastic coupling in disc construction having a damping device, in particular for a motor vehicle drivetrain, according to the preamble of claim 1. Such elastic couplings having damping devices are to keep the torsional vibrations, which the internal combustion engine generates, away from the downstream drivetrain. No or only slight damping is advantageously to occur between the two coupling halves in the case of a small relative pivot angle, while in contrast comparatively strong damping is to occur at larger pivot angles. This characteristic is particularly to be set independently of load, i.e., independently of whether the elastic coupling is currently transmitting a large or small torque. In particular, even during the transmission of high torques and in the case of simultaneous torsional vibrations having small amplitude, no or only slight damping is to be set, and stronger damping is only to occur in the case of torsional vibrations having comparatively greater amplitude, both for a small torque and also for a large torque.

A known elastic coupling in disc construction, which achieves the desired characteristic, is disclosed in documents DE 39 23 749 C1 and DE 102 41 103 A1. The two couplings shown therein each have a floating damping ring, which is introduced so it is pivotable to a limited extent in relation to both coupling halves in an inner space of the coupling which is filled with the damping medium and divides a damping chamber into partial chambers. The floating damping ring according to DE 102 41 103 A1 is divided over the circumference of the coupling into individual ring segments which are separate from one another, and which cooperate with cams oriented radially outward on the middle disc of the coupling, which forms the second coupling half, and cams oriented radially inward on an outer edge of the first coupling half, to form first partial chambers and second partial chambers, which change in their volume during the relative pivot between first coupling half and second coupling half.

The features known in DE 102 41 103 A1 are summarized in the preamble of claim 1. Published applications DE 100 22 625 A1 and DE 199 07 414 A1 also disclose corresponding features.

Although the coupling according to the species has proven in practice to be extremely reliable and superior with respect to its characteristic, there is room for further improvements. It is thus desirable, for example, to amplify the damping characteristic in the range close to the maximum relative pivot between the first coupling half and the second coupling half, in particular beyond the prior hydraulic damping, advantageously without undesirably influencing the damping behavior in the remaining pivot angle range.

The present invention is therefore based on the problem of specifying an elastic coupling in disc construction which fulfills this wish. In particular, the elastic coupling is to be distinguished by minor structural modifications in relation to the proven embodiment and is nonetheless to have the desired amplified damping in the maximum relative rotational angle range.

The problem according to the invention is solved by an elastic coupling having the features of claim 1. Particularly advantageous and expedient embodiments of the invention are specified in the dependent claims.

The inventors have succeeded, through only a minimal modification on the proven coupling having floating damping ring, the damping ring being divided into individual ring segments, in providing the desired additional damping in the range of large pivot angles between the first coupling half and the second coupling half, in that they have incorporated so to speak a friction damping into the coupling in the range of large pivot angles. This friction damping is achieved by producing a frictional contact surface between the axial end areas of the ring segments of the floating damping ring and the outer peripheral areas of the middle disc facing toward them and/or inner peripheral areas of at least one side disc. According to the invention, the coupling is designed in such a manner that the contact between at least one axial end of each ring segment (fundamentally, it would also suffice if only a single ring segment were implemented according to the invention) and the middle disc or the outer edge of at least one side disc is only effective in the peripheral direction through the damping medium or a state of the ring segment loaded by both coupling halves, while in contrast in the state of the ring segment which is not loaded in the peripheral direction by the damping medium or one of the two coupling halves, a predefined spacing is set in the radial direction of the coupling between the axial end of the ring segment and the middle disc and/or the outer edge of at least one side disc.

According to a particularly advantageous embodiment, the spacing bridged in the loaded state of the ring segment is produced between one axial end of each ring segment and the middle disc, while in contrast a pre-definable spacing which can be bridged between one axial end, in particular the opposite axial end, of the ring segment and the outer edge of the at least one side disc is only provided as an option, only partial bridging of the last mentioned spacing also coming into consideration here.

Specifically, an elastic coupling in disc construction according to the invention, which is particularly implemented for damping torsional vibrations of an internal combustion engine, has a first coupling half and a second coupling half, which are pivotable to a limited extent to one another against the force of at least one provided elastic coupling element. The first coupling half comprises two side discs which are connected in a rotationally-fixed manner on the outer circumference, and the second coupling half is formed by at least one middle disc assigned to a hub, which is arranged between the side discs and enveloped thereby.

The side discs delimit a liquid-tight inner space, which receives the middle disc, at least one damping chamber, which is changeable in volume during the mutual pivoting of the coupling halves and is filled with a damping medium, being arranged in the radial outer area of the inner space.

A floating damping ring, which is pivotable to a limited extent in relation to each of the two coupling halves, is introduced into the inner space, which forms at least one partial chamber of the damping chamber with the first coupling half and forms at least one second partial chamber of the damping chamber with the second coupling half, the floating damping ring being divided over the circumference of the coupling into individual ring segments which are separate from one another, and which are mounted in a sliding manner on the radial exterior on the middle disc and/or on the radial interior on an outer edge of at least one side disc.

According to the invention, the ring segments are arranged at one or both axial ends having the predefined spacing in the radial direction of the coupling in the unloaded state in relation to the middle disc and/or the outer edge of at least one side disc, this predefined spacing being bridged in the loaded state of the ring segments, in order to produce a sliding friction by contact on the middle disc and/or the outer edge of the at least one side disc.

The hydraulic damping can be amplified in the range of comparatively large relative pivot angles between the first coupling half and the second coupling half in that the cross-section of one partial chamber, in particular the first partial chamber, is implemented as comparatively reduced in the direction toward the axial ends of the ring segments, in particular having a first, comparatively large cross-section in the axial middle of the ring segments and having a comparatively smaller cross-section in each case in the area over a predefined axial extension before the axial ends, each in relation to an axial section through the coupling. The different areas can be provided, for example, by forming a “bathtub” in the middle area of the ring segments. This will be explained in greater detail hereafter.

In particular if a ring segment which is tiltable in relation to the middle disc in a plane through a radial section of the coupling is provided, this can advantageously be supported externally on the middle disc via a tilting point or tilting area, in the unloaded state or continuously. According to one embodiment it is also possible that the tilting point or tilting area is positioned in the axial middle of the ring segments in the unloaded state of the ring segments, and travels in the direction of an axial end of the ring segments with increasing load.

In particular in order to achieve such a tilting point or tilting area, but also in other embodiments, for example, having a bendable ring segment, a radial inner contour of the ring segments can be provided, which deviates from a radial outer contour of the middle disc facing toward it. 130th contours can be designed in the form of a circular line according to one embodiment, but can be implemented having different circle diameters, the circle diameter of the ring segment typically being greater than the circle diameter of the contour of the middle disc.

The sliding contact surfaces between the ring segments and one or both coupling halves can be lubricated by means of damping medium from the damping chamber.

Furthermore, it is possible to provide a temperature-dependent reduction of the spacing between the axial end of the ring segments and the middle disc and/or the outer edge of at least one side disc, the spacing in particular decreasing with increasing temperature of the damping medium or the ring segment. In the latter case, more rapidly beginning friction damping can be achieved in comparison to lower temperatures of the damping medium in particular, which counteracts reduced hydraulic damping, which can occur under specific circumstances with increasing temperature of the damping medium,

This temperature-dependent change of the play between the axial end of the ring segments and the assigned component—outer edge of the at least one side disc or middle disc—can be achieved, for example, in that the ring segments are designed in such a manner that they either straighten out or curve with increasing temperature, depending on whether the friction is to be amplified on the radial outer side of the ring segments or on the radial inner side of the ring segments.

The invention is to be described for exemplary purposes hereafter on the basis of an exemplary embodiment and the appended figures.

In the figures:

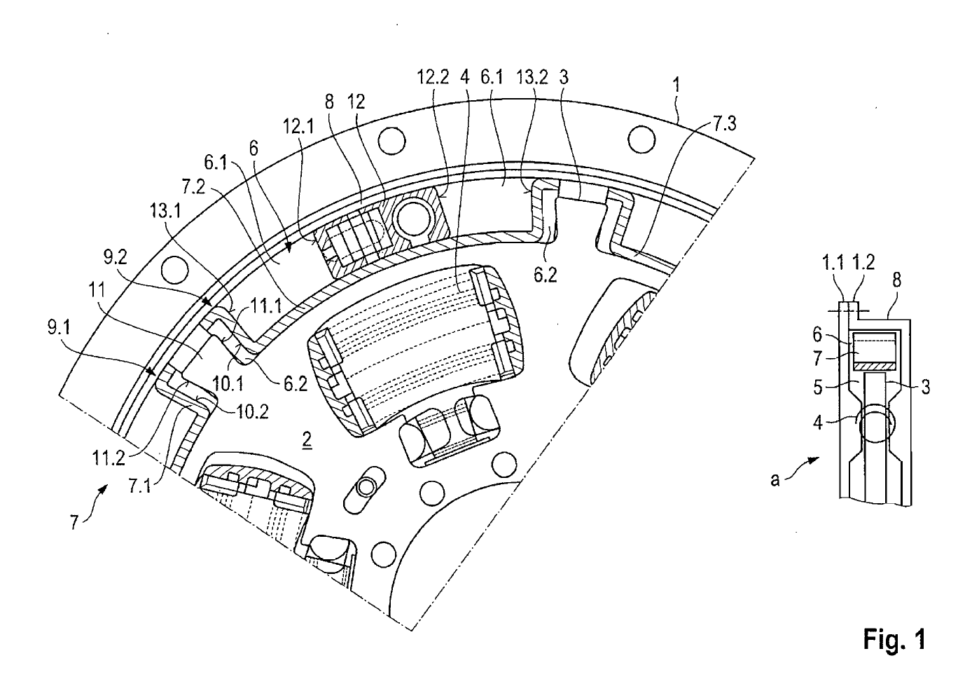

FIG. 1 shows a detail of an axial section through an elastic coupling implemented according to the invention, the spacing set according to the invention between ring segment and middle disc or ring segment and outer edge of the side disc not yet being recognizable, however;

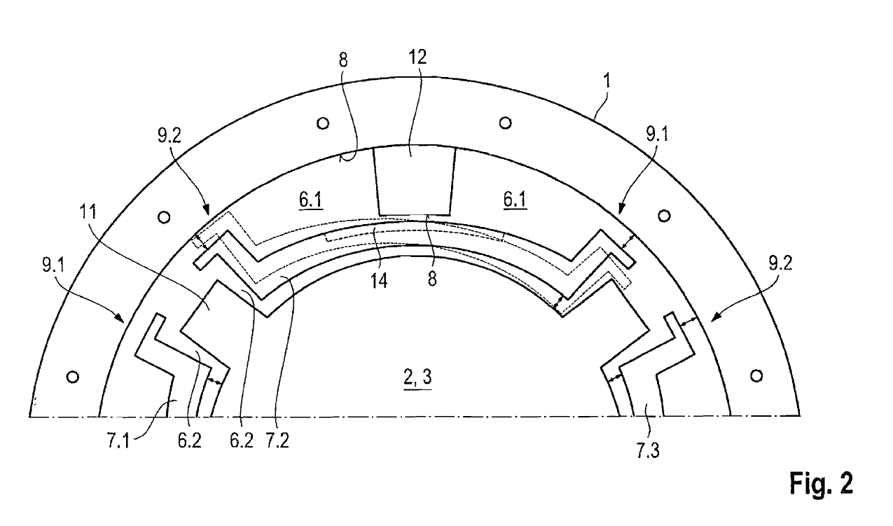

FIG. 2 shows a schematic enlarged illustration (not to scale), to explain the spacing provided according to the invention, which will typically be less pronounced in practice, however.

In FIG. 1, the first coupling half 1 is shown, which, as schematically shown in the detail a, comprises two side discs 1.1 and 1.2, which are connected in a rotationally-fixed manner on the outer circumference. The first coupling half 1 encloses a second coupling half 2, the two coupling halves 1, 2 being pivotable in a rotationally elastic and limited manner relative to one another via elastic coupling elements 4. For example, the two coupling halves 1, 2, as shown here, are supported against one another via compression springs in the peripheral direction of the coupling, corresponding support surfaces being provided for the compression springs on the side discs 1.1, 1.2 and the second coupling half 2. For example, the support surfaces are implemented by projections on the side discs 1.1, 1.2 according to the detail a.

The second coupling half 2 is formed by a middle disc 3, which is received in an inner space 5, which is delimited by the two side discs 1.1, 1.2.

A plurality of damping chambers 6, which are filled with a damping medium and are changed in volume during the mutual pivoting of the coupling halves 1, 2, are arranged in the radial outer area of the inner space 5.

Furthermore, a floating damping ring 7 is provided, which is divided over the circumference of the coupling into individual ring segments 7.1, 7.2, and 7.3, which are separate from one another. The damping ring 7 or its ring segments 7.1, 7.2, 7.3 slide on the radial exterior on the middle disc 3 and on the radial interior on an outer edge 8 of the side discs 1.1, 1.2. In the present case, the outer edge 8 is also formed by cams 12, which protrude radially inward from at least one of the two side discs 1.1, 1.2 and have opposing delimitation surfaces 12.1, 12.2, which face toward diametrically opposite delimitation surfaces 13.1 and 13.2 of the ring segments 7.1, 7.2, 7.3.

The middle disc 3 has cams 11, which protrude radially outward, however. The cams 11 have stop surfaces 11.1, 11.2, which also extend in the radial direction, and which are diametrically opposite to the stop surfaces 10.1, 10.2 on the two axial ends 9.1, 9.2 of the ring segment 7.1, 7.2, 7.3, which also extend in the radial direction.

Each damping chamber 6 is divided by a ring segment 7.1, 7.2, 7.3 into two partial chambers 6.1, 6.2. In the embodiment shown, each axial end 9.1, 9.2 of each ring segment 7.1, 7.2, 7.3 divides one damping chamber 6 into the two partial chambers 6.1, 6.2.

In the embodiment shown, the first partial chambers 6.1 are therefore each arranged between one ring segment 7.1, 7.2, 7.3 and the first coupling half 1 or its cams 12, while in contrast the second partial chambers 6.2 are each arranged between one ring segment 7.1, 7.2, 7.3 and the middle disc 3 or its cam 11.

If the second coupling half 2 is now relatively pivoted in relation to the first coupling 1, initially one of the two stop surfaces 11.1, 11.2 of the second coupling half 2 approaches the assigned stop surface 10.1, 10.2 of the ring segments 7.1, 7.2, 7.3, depending on the rotational direction, damping medium from the second partial chamber 6.2, which becomes smaller, flowing into the second partial chamber 6.2, which is connected via a damping gap, and which is simultaneously enlarged and is positioned in the present case on the respective other side in the peripheral direction of the respective cam 11, By setting a particularly large damping gap, the damping can be minimized or even turned off. At the moment at which the stop surface 11.1 strikes against the stop surface 10.1 or, in the case of reverse rotational direction, the stop surface 11.2 strikes against a stop surface 10.2, the corresponding ring segment 7,1, 7.2, 7.3 is engaged and relatively pivoted in relation to the first coupling half and its cam 12. In this way, a first partial chamber 6.1 on one side of each cam 12 is made smaller, and the assigned first partial chamber 6,1 on the other side of the cam 12 is enlarged, damping medium flowing from the first partial chamber 6.1, which become smaller, into the enlarging first partial chamber 6.1. The connection between these two chambers is produced via a comparatively small damping gap, so that the desired damping occurs.

In the first partial chamber 6.1, which becomes smaller, a hydraulic pressure is built up, which causes a tilting or bending effect on the ring segment 7.1, 7.2, 7.3 in the meaning of a movement toward the middle disc 3. The following occurs:

As may be seen in FIG. 2, a predetermined spacing is provided in the area of the axial ends 9.1, 9.2 of the ring segment 7.1, 7.2, 7.3 in the radial direction of the coupling between the ring segment 7.1, 7.2, 7.3, more precisely its inwardly directed surface, and the middle disc 3 or its outwardly directed surface, as long as damping pressure has not yet built up in the first partial chamber 6.1, and the ring segment 7.1, 7.2, 7.3 is accordingly not yet loaded in the peripheral direction by the damping medium or the first coupling half 1. If the mentioned bending force or tilting force is applied to the ring segment 7.1, 7.2, 7.3 from the hydraulic pressure or damping pressure in the first partial chamber 6.1, this spacing is bridged and the ring segment 7.1, 7.2, 7.3 comes into contact in a frictional manner on the middle disc 3. This is illustrated on the basis of the ring segment 7.2 at its first axial end 9.1 by the dashed line.

Depending on whether the ring segment 7.1, 7.2, 7.3 is arranged in a bending or tilting manner between the middle disc 3 and the first coupling half 1 or its outer edge 8, the spacing provided according to one embodiment in the unloaded state of the ring segment 7.1, 7.2, 7.3 between the first or second axial end 9.1, 9.2 of the ring segment 7.1, 7.2, 7.3 and the edge 8 is also bridged. This is shown in FIG. 2 at the second axial end 9.2 of the ring segment 7.2 on the basis of the dashed line. If the outer edge 8 of the first coupling half 1 is produced as comparatively thin-walled, in particular from sheet metal, it can be necessary to provide a contact surface which is moved in the axial direction of the coupling between outer edge 8 and the first or second axial end 9.1, 9.2 of the ring segment 7.1, 7.2, 7.3, at which friction occurs.

By bridging one or the other spacing (radially inward or radially outward on the ring segment 7.1, 7.2, 7.3), a frictional damping is generated, which is inactive as long as the spacing is produced,

The mentioned predefined spacings or the one predefined spacing in the unloaded state of the ring segments 7.1, 7.2, 7.3 can be implemented as comparatively small, since only the occurrence of an undesired or undesirably high frictional force is to be avoided, as long as the targeted spacing bridging has not occurred. For example, the spacing can be in the range of 0.5 to 2 mm, in particular between 0.5 and 1,5 mm or 0.5 and 1 mm. However, other, particularly greater spacings are possible, but smaller spacings are also optionally possible.

Furthermore, the formation of an enlargement of the damping gap between the two first partial chambers 6.1 on both sides of the cam 12 in the form of a so-called bathtub 14 is shown in FIG. 2, which is always active as long as the associated ring segment, the ring segment 7.2 here, is located in its axial middle position.

Although the ring segments 7.1, 7.2, 7.3 are shown having axial right-angle bends, which extend radially outward beyond the cams 11, in the area of their axial ends 9.1, 9.2 in the figures, this is only an option which can be omitted.

1-10. (canceled)

11. An elastic coupling in disc construction, in particular for damping torsional vibrations of an internal combustion engine, having the following features:
a first coupling half, which comprises two side discs, which are connected in a rotationally-fixed manner on the outer circumference;
a second coupling half, which is formed by at least one middle disc assigned to a hub, which is arranged between the side discs and enveloped thereby;
the two coupling halves are pivotable to a limited extent to one another against the force of at least one elastic coupling element;
the side discs delimit a liquid-tight inner space, which receives the middle disc;
at least one damping chamber, which is variable in volume during the mutual pivoting of the coupling halves and is filled with a damping medium, is arranged in the radial outer area of the inner space;
a floating damping ring, which is pivotable to a limited extent in relation to each of the two coupling halves, is introduced into the inner space, the damping ring forming at least one first partial chamber of the damping chamber with the first coupling half and forming at least one second partial chamber of the damping chamber with the second coupling half;
the floating damping ring being divided over the circumference of the coupling into individual ring segments, which are separate from one another, and which are mounted to slide on the radial exterior on the middle disc and/or on the radial interior on an outer edge of at least one side disc;
characterized in that:
in the state which is not loaded in the peripheral direction by the damping medium or one of the two coupling halves, the ring segments, at one or both axial ends, have a predefined spacing in the radial direction of the coupling in relation to the middle disc and/or in relation to the outer edge of at least one side disc; and
the ring segments are mounted in a bending or tilting manner on the middle disc and/or at least one side disc in such a manner that the predefined spacing at the axial end of the ring segments in relation to the middle disc and/or the outer edge of at least one side disc is bridged by bending or tilting in the state of the ring segments which is loaded in the peripheral direction by the damping medium or one of the two coupling halves.

12. The elastic coupling according to claim 11, characterized in that, in axial sections through the coupling, the cross-section of one partial chamber is implemented as reduced in the direction toward the axial ends of the ring segments, in particular having a first, comparatively greater cross-section in the axial middle of the ring segments and having a comparatively smaller cross-section in each case in the area before the axial ends.

13. The elastic coupling according to claim 11, characterized in that the ring segments, in the state which is not loaded in the peripheral direction by the damping medium or one or both coupling halves or continuously, are supported on the radial exterior on the middle disc in the area of their axial middle.

14. The elastic coupling according to claim 12, characterized in that the ring segments, in the state which is not loaded in the peripheral direction by the damping medium or one or both coupling halves or continuously, are supported on the radial exterior on the middle disc in the area of their axial middle.

15. The elastic coupling according to claim 13, characterized in that a radial inner contour of the ring segments deviates from a radial outer contour of the middle disc facing toward it, in particular both contours being implemented in the form of a circular line, but having different circle diameters.

16. The elastic coupling according to claim 14, characterized in that a radial inner contour of the ring segments deviates from a radial outer contour of the middle disc facing toward it, in particular both contours being implemented in the form of a circular line, but having different circle diameters.

17. The elastic coupling according to claim 11, characterized in that the sliding contact surfaces between the ring segments and the two coupling halves are lubricated by means of damping medium from the damping chamber.

18. The elastic coupling according to claim 12, characterized in that the sliding contact surfaces between the ring segments and the two coupling halves are lubricated by means of damping medium from the damping chamber.

19. The elastic coupling according to claim 13, characterized in that the sliding contact surfaces between the ring segments and the two coupling halves are lubricated by means of damping medium from the damping chamber.

20. The elastic coupling according to claim 14, characterized in that the sliding contact surfaces between the ring segments and the two coupling halves are lubricated by means of damping medium from the damping chamber.

21. The elastic coupling according to claim 15, characterized in that the sliding contact surfaces between the ring segments and the two coupling halves are lubricated by means of damping medium from the damping chamber.

22. The elastic coupling according to claim 16, characterized in that the sliding contact surfaces between the ring segments and the two coupling halves are lubricated by means of damping medium from the damping chamber.

23. The elastic coupling according to claim 11, characterized in that the spacing in the radial direction between the axial ends of the ring segments and the middle disc and/or the outer edge of at least one side disc changes, in particular decreases, as a function of the temperature of the damping medium and/or the ring segments.

24. The elastic coupling according to claim 12, characterized in that the spacing in the radial direction between the axial ends of the ring segments and the middle disc and/or the outer edge of at least one side disc changes, in particular decreases, as a function of the temperature of the damping medium and/or the ring segments.

25. The elastic coupling according to claim 13, characterized in that the spacing in the radial direction between the axial ends of the ring segments and the middle disc and/or the outer edge of at least one side disc changes, in particular decreases, as a function of the temperature of the damping medium and/or the ring segments.

26. The elastic coupling according to claim 14, characterized in that the spacing in the radial direction between the axial ends of the ring segments and the middle disc and/or the outer edge of at least one side disc changes, in particular decreases, as a function of the temperature of the damping medium and/or the ring segments.

27. The elastic coupling according to claim 23, characterized in that the ring segments are designed in such a manner that they straighten out or curve with increasing temperature.

28. The elastic coupling according to claim 11, characterized in that the ring segments are arranged in such a manner that they always rest on a tilting point or over a tilting area on the middle disc, and the tilting point or tilting area moves in the direction toward an axial end of the ring segments with increasing relative pivoting between the first coupling half and the floating damping ring or between the second coupling half and the floating damping ring.

29. The elastic coupling according to claim 11, characterized in that the ring segments, on each of their two axial ends, have a stop surface, which, upon relative pivoting between the first coupling half or the second coupling half and the floating damping ring, strikes against stop surfaces, which are arranged opposite, of the first coupling half or the second coupling half.

30. The elastic coupling according to claim 11, characterized in that each ring segment forms two damping chambers having first and second partial chambers with the first coupling half and the second coupling half.
